(19) United States
(12) Patent Application Publication
(10) Pub. No.: US 2023/0132616 A1
(43) Pub. Date: May 4, 2023

(54) LASER RADAR SYSTEM AND DETECTION METHOD

(71) Applicant: HUAWEI TECHNOLOGIES CO., LTD., Shenzhen (CN)

(72) Inventors: Yilun Zhou, Shanghai (CN); Kai An, Shanghai (CN)

(21) Appl. No.: 18/148,940

(22) Filed: Dec. 30, 2022

Related U.S. Application Data
(63) Continuation of application No. PCT/CN2021/082834, filed on Mar. 24, 2021.

(30) Foreign Application Priority Data
Jun. 30, 2020 (CN) 202010620891.6

(51) Int. Cl. G01S 17/18; G01S 7/481; G01S 17/894

(52) U.S. Cl. CPC G01S 17/18; G01S 7/4817; G01S 7/4816; G01S 17/894

(57) ABSTRACT

A laser includes a light source, a scanning unit, a receiving lens, a homogenizing unit, a light detection unit, and a processing unit. The light source is configured to output a laser beam. The scanning unit is configured to guide the laser beam to a specified region. The receiving lens is configured to converge an echo light signal formed through reflection of the laser beam. The homogenizing unit is configured to uniformly emit the converged echo light signal onto a photosensitive pixel of the light detection unit, which includes a plurality of photosensitive cells. The plurality of photosensitive cells are used to convert the received echo light signal into an echo electrical signal and are controlled by a plurality of gating circuits. The processing unit is configured to analyze an echo electrical signal output by the plurality of photosensitive cells in a gating period.

### CROSS-REFERENCE TO RELATED APPLICATIONS

This application is a continuation of International Application No. PCT/CN2021/082834, filed on Mar. 24, 2021, which claims priority to Chinese Patent Application No. 202010620891.6, filed on Jun. 30, 2020. The disclosures of the aforementioned applications are hereby incorporated by reference in their entireties.

### TECHNICAL FIELD

The present disclosure relates to the field of light detection, and in particular, to a laser radar system and a detection method.

### BACKGROUND

A laser radar is an active ranging system. A laser emits a laser light pulse. When the pulse encounters an object, the pulse is reflected to form an echo light pulse. A photoelectric detector in the laser radar system receives the echo light pulse, measures a time of flight of the laser light pulse, and obtains, through calculation, information such as a distance between the object and the laser radar system.

A gating ranging method may be used, to avoid false triggering of interference light and reduce an effective false detection rate under a same optical signal-to-noise ratio. In the gating ranging method, targets with different distances from each other in a same target field of view are separately detected a plurality of times at different time points, to be specific, each time a laser emits one laser light pulse, after different time periods, a photoelectric detector in a receiver is gated to receive an echo light pulse. After the plurality of detections, a full-range ranging of the target field of view is formed. However, it takes a long time to complete such a detection manner once, the ranging is slow, and detection efficiency is very low.

### SUMMARY

Embodiments of the present invention provide a laser radar system, which implements fast gating ranging and reduces a false detection rate of the system.

According to a first aspect, an embodiment of the present invention provides a laser radar system. The laser radar system includes a light source, a scanning unit, a receiving lens, a homogenizing unit, a light detection unit, and a processing unit. The light source is configured to output a laser beam. The scanning unit is configured to guide the laser beam to a specified region. The receiving lens is configured to converge an echo light signal formed through reflection of the laser beam. The homogenizing unit is configured to uniformly emit the converged echo light signal onto a photosensitive pixel of the light detection unit. The photosensitive pixel of the light detection unit includes a plurality of photosensitive cells, the plurality of photosensitive cells are used to convert the received echo light signal into an echo electrical signal, and the plurality of photosensitive cells are controlled by a plurality of gating circuits. The processing unit is configured to analyze an echo electrical signal output by the plurality of photosensitive cells in a gating period.

After a laser beam is emitted once, a plurality of photosensitive cells are gated to detect echoes, to implement fast gating ranging.

In an embodiment, a light spot of the echo light signal converged by the receiving lens is not greater than a light incident surface of the homogenizing unit, and an emergent light spot of the homogenizing unit covers a photosensitive surface of the light detection unit. In this way, a loss of an optical path is reduced.

In still another embodiment, the homogenizing unit includes one of the following: a homogenizing prism, a homogenizing rod, and a diffuser. Different elements improve flexibility of the system.

In yet another embodiment, one gating circuit controls gating of at least two photosensitive cells, thereby increasing efficiency of the system.

In still yet another embodiment, the processing unit is further configured to control the light source and the scanning unit to perform two-dimensional region scanning, thereby improving the flexibility of the system.

In a further embodiment, the processing unit is further configured to control one or more gating circuits, and a photosensitive cell gated during a gating period receives an echo light signal and performs optical-to-electrical signal conversion, thereby implementing flexible control of the photosensitive cell.

In a still further embodiment, the processing unit is configured to perform the following steps: configuring a plurality of gating modes; driving the light source to emit a laser beam; during a gating period of each gating mode, enabling a photosensitive cell gated in the gating mode to receive an echo light signal of the laser beam; and analyzing an echo electrical signal output by the gated photosensitive cell, and combining the echo electrical signal into an imaging parameter of one pixel. In this way, fast gating ranging is implemented.

In a yet further embodiment, a plurality of gating modes are combined into full-range gating for one ranging, to implement one full-range time-of-flight detection.

In a still yet further embodiment, the gating period of each gating mode includes a plurality of gating time periods. In a gating time period, a photosensitive cell corresponding to a gating mode receives an echo light signal. This improves the flexibility of the system.

In even yet another embodiment, a quantity of photosensitive cells gated in one gating mode is greater than or equal to 2, thereby improving flexibility of system configuration.

According to a second aspect, an embodiment of the present invention provides a detection method, including the steps performed by the foregoing processing unit.

According to a third aspect, an embodiment of the present invention provides a detection apparatus, including a processor and a memory. The processor is configured to invoke a program stored in the memory to perform the foregoing detection method.

### BRIEF DESCRIPTION OF DRAWINGS

FIG. 1 is a schematic diagram of a structure of a laser radar system according to an embodiment of the present invention;

FIG. 2 is a schematic diagram of a photosensitive cell included in a light-sensitive surface of a detector according to an embodiment of the present invention;

FIG. 3 is a schematic diagram of a positional relationship between a receiving lens and a homogenizing unit according to an embodiment of the present invention;

FIG. 4 is another schematic diagram of a positional relationship between a receiving lens and a homogenizing unit according to an embodiment of the present invention;

FIG. 5 is a schematic diagram of a detection method according to an embodiment of the present invention;

FIG. 6 is a schematic diagram of a full-range detection method according to an embodiment of the present invention;

FIG. 7 is a schematic diagram of a gating circuit corresponding to FIG. 6 according to an embodiment of the present invention;

FIG. 8 is another schematic diagram of a full-range detection method according to an embodiment of the present invention;

FIG. 9 is a schematic diagram of a gating circuit corresponding to FIG. 8 according to an embodiment of the present invention;

FIG. 10 is still another schematic diagram of a full-range detection method according to an embodiment of the present invention;

FIG. 11 is a schematic diagram of a gating circuit corresponding to FIG. 10 according to an embodiment of the present invention; and

FIG. 12 is a schematic diagram of a structure of a detection apparatus according to an embodiment of the present invention.

### DESCRIPTION OF EMBODIMENTS

To make the objectives, technical solutions, and advantages of the present disclosure clearer, the following further describes embodiments of the present invention in detail with reference to the accompanying drawings.

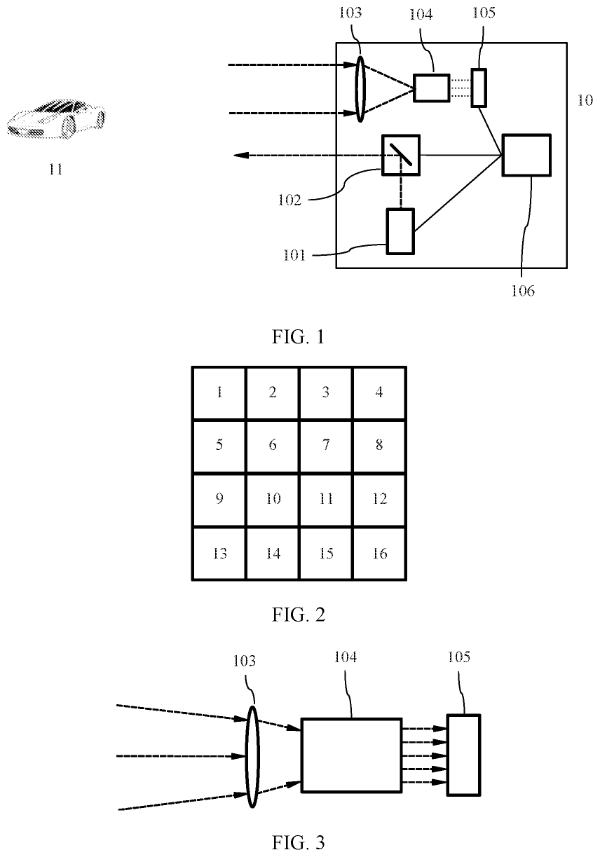

Embodiments of the present invention provide a laser radar system. As shown in FIG. 1, a laser radar system 10 includes a light source 101, a scanning unit 102, a receiving lens 103, a homogenizing unit 104, a light detection unit 105, and a processing unit 106.

The light source 101 is configured to output a laser beam.

The scanning unit 102 is configured to perform two-dimensional scanning in a specified region, and after continuous two-dimensional scanning and processing of a received echo light signal, a three-dimensional image is finally formed. The scanning unit may be a micro-galvo mirror actuator manufactured by using a micro-electro-mechanical systems (MEMS) technology, a micro-rotating prism, or the like.

The receiving lens 103 is configured to converge an echo light signal formed through reflection from an object 11.

The homogenizing unit 104 is configured to homogenize the echo light signal, so that the echo light signal is uniformly received by a plurality of photosensitive cells of the light detection unit.

The light detection unit 105 is configured to convert the echo light signal into an echo electrical signal. A photosensitive pixel of the light detection unit includes a plurality of photosensitive cells, and each photosensitive cell has an optical-to-electrical conversion capability and has an independent or combined gating circuit.

The plurality of photosensitive cells included in the photosensitive pixel of the light detection unit may be arranged in a shape of an M×N rectangle, where M and N are positive integers greater than 1. In the following embodiments, 4×4=16 photosensitive cells shown in FIG. 2 are used as an example, and the photosensitive cells are numbered 1 to 16. Each photosensitive cell has an optical-to-electrical conversion capability and has an independent gating circuit, or a plurality of photosensitive cells are combined to share one gating circuit.

The processing unit 106 is configured to control operation of the light source 101, the scanning unit 102, and the light detection unit 105, and analyze an echo electrical signal to form a three-dimensional image.

A laser beam emitted by the radar system, after encountering an object ahead, is reflected to form an echo light signal. Apart of the echo light signal sequentially passes through the receiving lens and the homogenizing unit, and is then emitted onto a photosensitive surface of the light detection unit. After passing through the receiving lens, the echo light signal usually forms a focused Gaussian beam. If there is no homogenizing unit, a focused light spot is usually formed on the photosensitive surface of the light detection unit, so that photosensitive cells on the photosensitive surface receive light with different light intensities. After the homogenizing unit homogenizes an echo light signal, a uniform light spot can be formed on the photosensitive surface of the light detection unit. Usually, the homogenizing unit may be a device such as a homogenizing prism or a homogenizing rod, and a diffuser may be further added to achieve a better homogenizing effect.

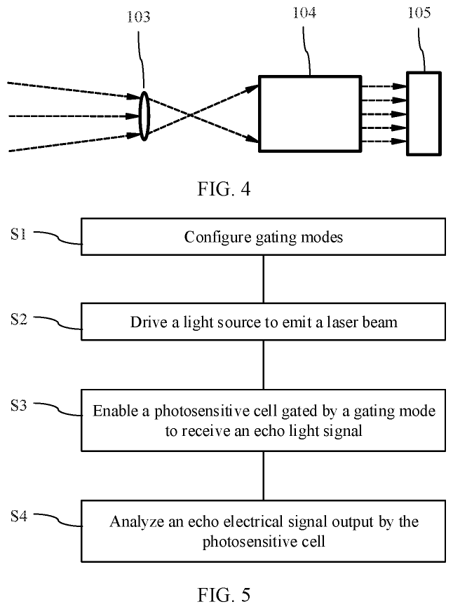

The focused Gaussian beam converged by the receiving lens needs to have a light spot not greater than a light incident surface of the homogenizing unit, so that there is no energy loss. An emergent light spot of the homogenizing unit needs to cover a photosensitive surface of the light detection unit, so that each photosensitive cell on the photosensitive surface uniformly senses light, and there is no energy loss. Depending on a size of a receiving lens that is selected, a positional relationship between the receiving lens and the homogenizing unit can be configured as shown in FIG. 3 or FIG. 4.

Applied to the laser radar system shown in FIG. 1, an embodiment of the present invention further provides a detection method. As shown in FIG. 5, the method includes the following steps.

S1. Configure a plurality of gating modes. Before a ranging, a gating mode of a gating circuit that controls each photosensitive cell can be preconfigured. After a laser beam is emitted, each photosensitive cell can be enabled based on the preconfigured gating mode to receive an echo light signal.

S2. Drive the light source to emit a laser beam.

S3. In a gating period of each gating mode, enable a gated photosensitive cell to receive an echo light signal of the laser beam. The photosensitive cell converts the received echo light signal into an electrical signal.

S4. Analyze the echo electrical signal output by the gated photosensitive cell, and combine the echo electrical signal into an imaging parameter of one pixel. Further, a plurality of gating modes may be combined into full-range gating for one ranging.

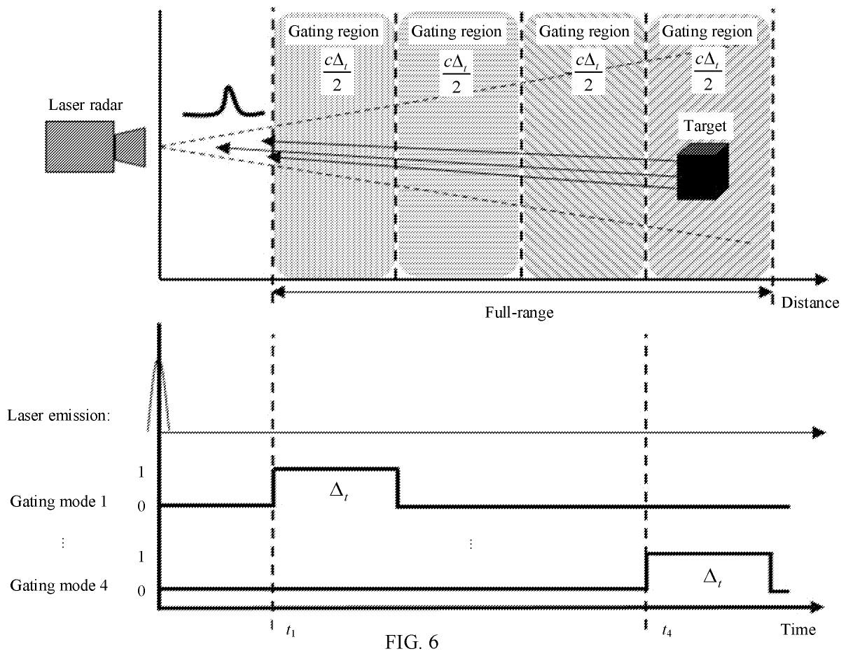

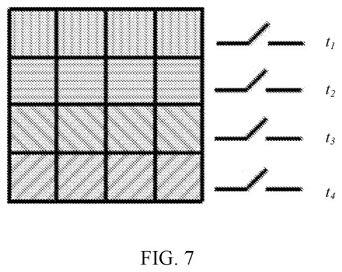

An embodiment of the present invention further provides a more specific detection method. Referring to FIG. 6 and FIG. 7, the method includes the following steps.

1. Configure a gating mode. A gating mode of each photosensitive cell is determined based on different system conditions, such as a quantity of photosensitive cells of a light detection unit, a ranging range, an optical signal-to-noise ratio, a weather condition, and a density degree of objects in a target region.

As shown in FIG. 6, a full range of a ranging is divided into four equal gating regions, and a length of each gating region is Δd. The light detection unit is controlled to be turned on in a corresponding time window, so that an echo light signal formed through reflection from an object in the gating region is received. Δt=(2×Δd)/c, and c is a speed of light. Therefore, the light detection unit executes gating modes 1, 2, 3, and 4, and four photosensitive cells are assigned to each gating mode for execution. As shown in FIG. 7, photosensitive cells 1 to 4 execute the gating mode 1, and are turned on at a moment t1, and duration is Δt; photosensitive cells 5 to 8 execute the gating mode 2, and are turned on at a moment t2, and duration is Δt; photosensitive cells 9 to 12 execute the gating mode 3, and are turned on at a moment t3, and duration is Δt; and photosensitive cells 13 to 16 execute the gating mode 4, and are turned on at a moment t4, and duration is Δt. In this way, all the photosensitive cells operate in cooperation with each other to implement full-range gating in a single ranging that uses laser beam emission, to be specific, a single time of flight (TOF) ranging.

2. A laser emits a laser beam, and an emitted collimated beam is emitted onto the scanning unit, and the scanning unit guides the beam to a target field of view.

Some echo light signals formed through reflection from the object enter a receiving lens. The homogenizing unit uniformly emits the echo light signal onto all photosensitive cells on a photosensitive surface of the light detection unit.

3. Control a gating circuit in a configured gating mode, so that each photosensitive cell receives an echo light signal of the laser beam within a specified time period, performs optical-to-electrical conversion, and outputs an echo electrical signal.

4. A processing unit analyzes and processes echo electrical signals output by all the photosensitive cells, and combines the echo electrical signals into an imaging parameter of one pixel, for example, obtaining a distance between objects in the target field of view.

In the embodiment shown in FIG. 6, lengths of turn-on time periods of gating modes are the same as each other, and quantities of photosensitive cells turned on in the time periods are the same as each other. When application scenarios are different, the lengths of the turn-on time periods of the gating modes may be different from each other, and the quantities of photosensitive cells turned on in the time periods may also be different from each other. For example, a ranging range needs to be expanded when a car travels at a high speed, and there is strong background light noise on sunny days. In these cases, an optical signal-to-noise ratio of ranging becomes poor, and the system needs to increase a quantity of detection photosensitive cells in a region with a relatively poor optical signal-to-noise ratio. For another example, when a quantity of objects in a specific region in a ranging environment increases, or when a focus is on a target in a specific detection interval, the laser radar system needs to increase density of a gating region. These operations can be implemented in preconfigured gating modes.

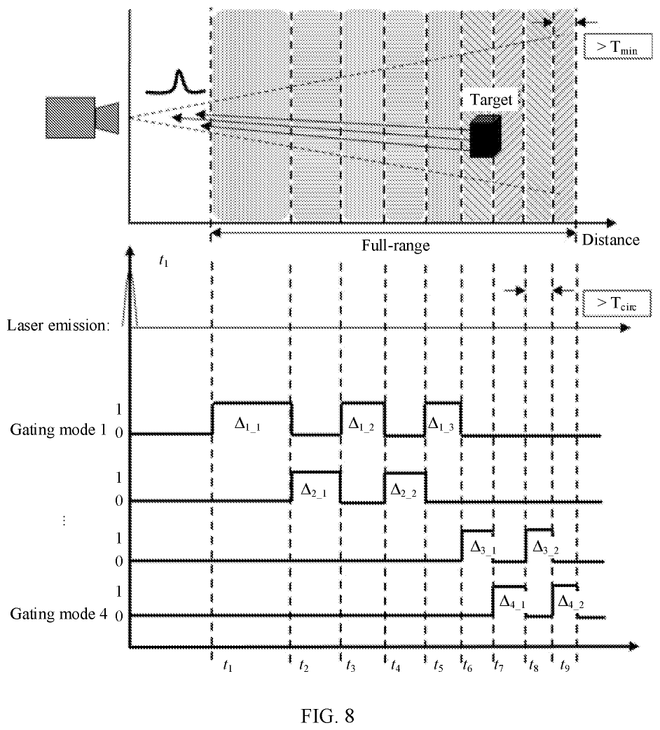

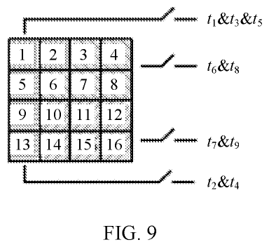

An embodiment of the present invention further provides a detection method. Referring to FIG. 8 and FIG. 9, the method includes the following steps.

1. Configure a gating mode. Here, a laser radar system needs to increase density of a gating region and increase a quantity of detection photosensitive cells in a region with a relatively poor optical signal-to-noise ratio.

As shown in FIG. 8, a full range of a ranging is divided into nine gating regions, and a length of each gating region is Lx, and x is separately 1 to 9. The light detection unit is controlled to be turned on in a corresponding time window, so that an echo light signal formed through reflection from an object in the gating region is received. Tx=(2×Lx)/c, c is a speed of light, a turn-on moment of each time period is tx, and x is separately 1 to 9. As shown in FIG. 8, ratios of L1 to L9 to a full-range length L are respectively 0.2, 0.13, 0.11, 0.11, 0.11, 0.09, 0.09, 0.09, and 0.07, and a sum of the ratios is 1. In other words, the gating region covers a full range. Lengths of some regions decrease stepwise with a ranging distance, and some regions have the same length.

As shown in FIG. 9, the light detection unit is disposed to execute gating modes 1, 2, 3, and 4, and quantities of photosensitive cells assigned to the gating modes are not equal. Photosensitive cells 1 and 2 execute the gating mode 1, and are turned on at moments t1, t3, and t5; photosensitive cells 5, 9, and 13 execute the gating mode 2, and are turned on at moments t2 and t4; photosensitive cells 3, 4, 6, 7, and 8 execute the gating mode 3, and are turned on at moments t6 and t8; and photosensitive cells 10, 11, 12, 14, 15, and 16 execute the gating mode 4, and are turned on at moments t7 and t9. In this way, all the photosensitive cells operate in cooperation with each other to implement full-range gating in a single ranging that uses laser beam emission, to be specific, a single time of flight (TOF) ranging.

2. A laser emits a laser beam, and an emitted collimated beam is emitted onto the scanning unit, and the scanning unit guides the beam to a target field of view.

Some echo light signals formed through reflection from the object enter a receiving lens. The homogenizing unit uniformly emits the echo light signal onto all photosensitive cells on a photosensitive surface of the light detection unit.

3. Control a gating circuit in a configured gating mode, so that each photosensitive cell receives an echo light signal of the laser beam within a specified time period, performs optical-to-electrical conversion, and outputs an echo electrical signal.

4. A processing unit analyzes and processes echo electrical signals output by all the photosensitive cells, and combines the echo electrical signals into an imaging parameter of one pixel, for example, obtaining a distance between objects in the target field of view.

In the embodiment shown in FIG. 8, the full range of the ranging is divided into nine gating regions. Usually, if a minimum gating time window of a detector photosensitive cell is Tmin, a total quantity of gating regions is not greater than 2×L/(c×Tmin), where L is a distance of a full range, and c is a speed of light. Each gating mode includes a plurality of gating time periods. If a minimum response time of a quenching circuit and a readout circuit of the detector photosensitive cell is Tcirc, in a gating mode of a photosensitive cell that detects a plurality of gating regions, an interval between adjacent gating time periods needs to be greater than Tcirc.

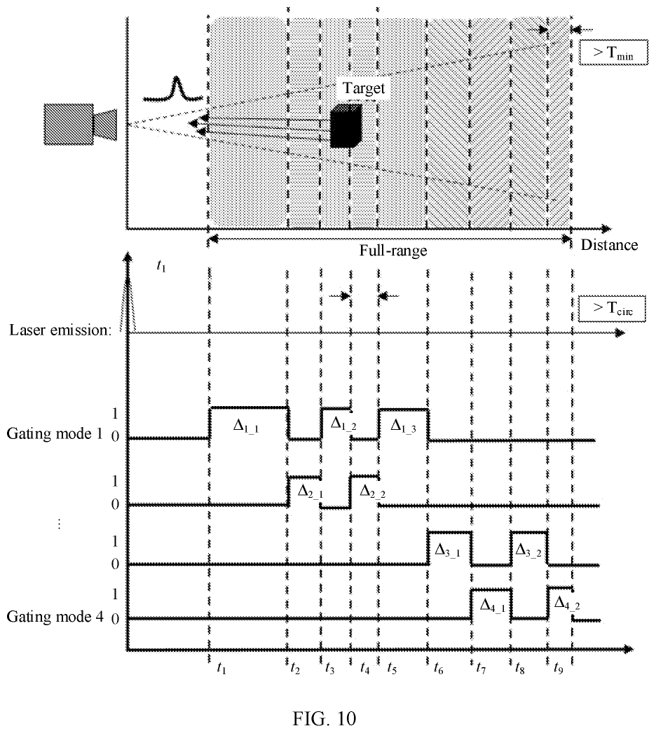

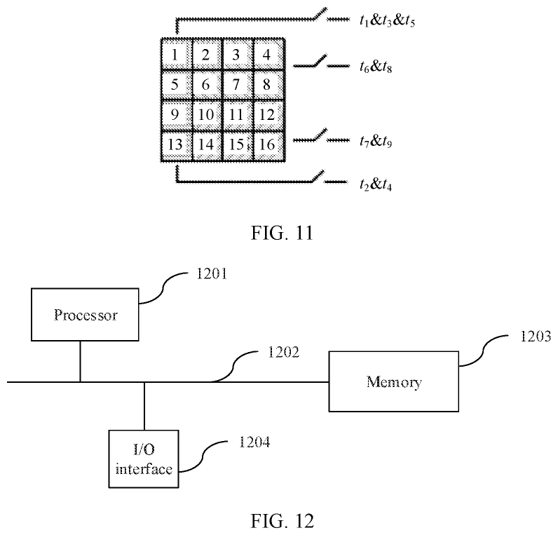

An embodiment of the present invention further provides a detection method, as shown in FIG. 10 and FIG. 11. Different from the foregoing method shown in FIG. 8, in this method, it is required to perform key detection on a region close to a laser radar system, and this method includes the following steps.

1. Configure a gating mode. Here, a laser radar system needs to increase density of a gating region and increase a quantity of detection photosensitive cells in a region with a relatively poor optical signal-to-noise ratio.

As shown in FIG. 10, a full range of a ranging is divided into nine gating regions, and a length of each gating region is Lx, and x is separately 1 to 9. The light detection unit is controlled to be turned on in a corresponding time window, so that an echo light signal formed through reflection from an object in the gating region is received. Tx=(2×Lx)/c, c is a speed of light, a turn-on moment of each time period is tx, and x is separately 1 to 9. As shown in FIG. 8, ratios of L1 to L9 to a full-range length L are respectively 0.2, 0.09, 0.09, 0.09, 0.13, 0.11, 0.11, 0.11, and 0.07, and a sum of the ratios is 1. In other words, the gating region covers a full range. Regions corresponding to L2 to L4 are used as key detection regions, and lengths assigned to the regions are shorter, which implements more dense detection.

As shown in FIG. 11, the light detection unit is disposed to execute gating modes 1, 2, 3, and 4, and quantities of photosensitive cells assigned to the gating modes are not equal. Photosensitive cells 1 and 2 execute the gating mode 1, and are turned on at moments t1, t3, and t5; photosensitive cells 5, 9, and 13 execute the gating mode 2, and are turned on at moments t2 and t4; photosensitive cells 3, 4, 6, 7, and 8 execute the gating mode 3, and are turned on at moments t6 and t8; and photosensitive cells 10, 11, 12, 14, 15, and 16 execute the gating mode 4, and are turned on at moments t7 and t9. In this way, all the photosensitive cells operate in cooperation with each other to implement full-range gating in a single ranging that uses laser beam emission, to be specific, a single time of flight (TOF) ranging.

2. A laser emits a laser beam, and an emitted collimated beam is emitted onto the scanning unit, and the scanning unit guides the beam to a target field of view.

Some echo light signals formed through reflection from the object enter a receiving lens. The homogenizing unit uniformly emits the echo light signal onto all photosensitive cells on a photosensitive surface of the light detection unit.

3. Control a gating circuit in a configured gating mode, so that each photosensitive cell receives an echo light signal of the laser beam within a specified time period, performs optical-to-electrical conversion, and outputs an echo electrical signal.

4. A processing unit analyzes and processes echo electrical signals output by all the photosensitive cells, and combines the echo electrical signals into an imaging parameter of one pixel, for example, obtaining a distance between objects in the target field of view.

Various gating modes are configured. This improves flexibility of the laser radar system and makes the laser radar system applicable in various environments.

The laser radar system in the embodiment of the present invention may alternatively be implemented by a computer device shown in FIG. 12. The computer device includes at least one processor 1201, a communications bus 1202, a memory 1203, and an I/O interface 1204.

The processor may be a general-purpose central processing unit (CPU), a microprocessor, an application-specific integrated circuit (ASIC), or one or more integrated circuits configured to control execution of programs in a solution of the present invention.

The communications bus may include a path that transfers information between the foregoing components.

The memory may be a read-only memory (ROM) or another type of static storage device that can store static information and instructions, or a random access memory (RAM) or another type of dynamic storage device that can store information and instructions, or may be an electrically erasable programmable read-only memory (EEPROM), a compact disc read-only memory (CD-ROM) or another optical disk storage, an optical disc storage (including a compact disc, a laser disc, an optical disc, a digital versatile disc, a Blu-ray disc, or the like), a disk storage medium or another magnetic storage device, or any other medium that can be used to carry or store expected program code in a form of instructions or a data structure and that can be accessed by a computer. However, the memory is not limited thereto. The memory may exist independently, and is connected to the processor through the bus. Alternatively, the memory may be integrated with the processor.

The memory is configured to store application program code for executing the solution of the present invention, and the execution of the application program code is controlled by the processor. The processor is configured to execute the program code stored in the memory.

In an embodiment, the processor may include one or more CPUs, and each CPU may be a single-core (single-core) processor or a multi-core (multi-Core) processor. Herein, the processor may be one or more devices, circuits, and/or processing cores configured to process data (for example, computer program instructions).

In an embodiment, the computer device further includes an input/output (I/O) interface configured to control the light source, the scanning unit, the light detection unit, and the like shown in FIG. 1. For example, the output device may be a liquid crystal display (LCD), a light emitting diode (LED) display device, a cathode ray tube (CRT) display device, or a projector (projector). The input device may alternatively be a mouse, a keyboard, a touchscreen device, or a sensing device.

The computer device may be a general-purpose computer device or a dedicated computer device. In a specific implementation, the computer device may be a desktop computer, a portable computer, a network server, a personal digital assistant (PDA), a mobile phone, a tablet computer, a wireless terminal device, a communications device, or an embedded device. Embodiments of the present invention do not limit a type of the computer device.

The processing unit in FIG. 1 may be the device shown in FIG. 12, and one or more software modules are stored in the memory. The software modules are implemented by the processor and the program code in the memory, to complete the foregoing method.

An embodiment of the present invention further provides a computer storage medium, configured to store computer software instructions, and the computer software instructions include a program designed to execute the foregoing method embodiment.

Although the present disclosure is described with reference to embodiments, in a process of implementing the present embodiments that claims protection, persons skilled in the art may understand and implement another variation of the disclosed embodiments by viewing the accompanying drawings, disclosed content, and the accompanying claims. In the claims, “comprising” (comprising) does not exclude another component or another step, and “a” or “one” does not exclude a case of multiple.

Although the present disclosure is described with reference to specific features and the embodiments thereof, it is clear that various modifications and combinations may be made. Correspondingly, this specification and the accompanying drawings are merely example description of the present embodiments defined by the appended claims, and are considered as any or all of modifications, variations, combinations, or equivalents that cover the scope of the present disclosure. Obviously, persons skilled in the art can make various modifications and variations to the present embodiments without departing from the scope of the present disclosure. The present disclosure is intended to cover these modifications and variations provided that they fall within the scope of protection defined by the following claims and their equivalent technologies.

1. A laser radar system, comprising a light source, a scanning unit, a receiving lens, a homogenizing unit, a light detection unit, and a processing unit, wherein
the light source is configured to output a laser beam;
the scanning unit is configured to guide the laser beam to a specified region;
the receiving lens is configured to converge an echo light signal formed through reflection of the laser beam;
the homogenizing unit is configured to uniformly emit the converged echo light signal onto a photosensitive pixel of the light detection unit;
the photosensitive pixel of the light detection unit comprises a plurality of photosensitive cells, the plurality of photosensitive cells are used to convert the received echo light signal into an echo electrical signal, and the plurality of photosensitive cells are controlled by a plurality of gating circuits; and
the processing unit is configured to analyze an echo electrical signal output by the plurality of photosensitive cells in a gating period.

2. The laser radar system according to claim 1, wherein a size of a light spot of the echo light signal converged by the receiving lens is not greater than a size of a light incident surface of the homogenizing unit, and an emergent light spot of the homogenizing unit covers a photosensitive surface of the light detection unit.

3. The laser radar system according to claim 1, wherein the homogenizing unit comprises one of the following: a homogenizing prism, a homogenizing rod, and a diffuser.

4. The laser radar system according to claim 1, wherein one gating circuit controls gating of at least two photosensitive cells.

5. The laser radar system according to claim 1, wherein the processing unit is further configured to control the light source and the scanning unit to perform two-dimensional region scanning.

6. The laser radar system according to claim 1, wherein the processing unit is further configured to control one or more gating circuits, and a photosensitive cell gated during a gating period receives an echo light signal and performs optical-to-electrical signal conversion.

7. The laser radar system according to claim 1, wherein the processing unit is configured to perform the following steps:
configuring a plurality of gating modes;
driving the light source to emit the laser beam;
during a gating period of each gating mode, enabling a photosensitive cell gated in the gating mode to receive an echo light signal of the laser beam; and
analyzing an echo electrical signal output by the gated photosensitive cell, and combining the echo electrical signal into an imaging parameter of one pixel.

8. The laser radar system according to claim 7, wherein a plurality of gating modes are combined into full-range gating for one ranging.

9. The laser radar system according to claim 7, wherein the gating period of each gating mode comprises a plurality of gating time periods; and in a gating time period, a photosensitive cell corresponding to a gating mode receives an echo light signal.

10. The laser radar system according to claim 7, wherein a quantity of photosensitive cells gated in one gating mode is greater than or equal to 2.

11. A detection method, comprising:
configuring a plurality of gating modes;
driving a light source to emit a laser beam;
during a gating period of each gating mode, enabling a photosensitive cell gated in the gating mode to receive an echo light signal of the laser beam; and
analyzing an echo electrical signal output by the gated photosensitive cell, and combining the echo electrical signal into an imaging parameter of one pixel.

12. The detection method according to claim 11, wherein a plurality of gating modes are combined into full-range gating for one ranging.

13. The detection method according to claim 11, wherein the gating period of each gating mode comprises a plurality of gating time periods; and in a gating time period, a photosensitive cell corresponding to a gating mode receives an echo light signal.

14. The detection method according to claim 11, wherein a quantity of photosensitive cells gated in one gating mode is greater than or equal to 2.

15. A detection apparatus, comprising a processor and a memory, wherein the processor is configured to invoke a program stored in the memory to perform a detection method comprising:
configuring a plurality of gating modes;
driving a light source to emit a laser beam;
during a gating period of each gating mode, enabling a photosensitive cell gated in the gating mode to receive an echo light signal of the laser beam; and
analyzing an echo electrical signal output by the gated photosensitive cell, and combining the echo electrical signal into an imaging parameter of one pixel.

16. The detection apparatus according to claim 15, wherein a plurality of gating modes are combined into full-range gating for one ranging.

17. The detection apparatus according to claim 15, wherein the gating period of each gating mode comprises a plurality of gating time periods; and in a gating time period, a photosensitive cell corresponding to a gating mode receives an echo light signal.

18. The detection apparatus according to claim 15, wherein a quantity of photosensitive cells gated in one gating mode is greater than or equal to 2.
